(19) United States
(12) Patent Application Publication
(10) Pub. No.: US 2026/0057332 A1
(43) Pub. Date: Feb. 26, 2026

(54) BLOCKCHAIN TRANSACTIONS BASED ON PARTICIPANT RANKING

(71) Applicant: THE CURATORS OF THE UNIVERSITY OF MISSOURI, Columbia, MO (US)

(72) Inventors: Vijay Anand, Clayton, MO (US); Haitao Li, St. Louis, MO (US)

(21) Appl. No.: 19/103,393

(22) PCT Filed: Aug. 29, 2023
(86) PCT No.: PCT/US2023/073088

§ 371 Date: Feb. 12, 2025

Related U.S. Application Data
(60) Provisional application No. 63/373,788, filed on Aug. 29, 2022.

(51) Int. Cl. G06Q 10/083; H04L 9/00

(52) U.S. Cl. CPC G06Q 10/083; H04L 9/50

(57) ABSTRACT

The present invention involves ranking participants, which determines participation in transactions that affects the processing of transactions and recording of the transactions in block computation. A new element in a block is called integrity rank, and every transaction is processed and recorded based on the rules of the integrity rank. Every transaction also has a ranking element, which is made operational through a smart contract that governs the participation of participants. Transactions will only be considered valid and persistent on-chain if the participants of that transaction conform to the ranking logic set by the smart contract. The logic for such transactions is encoded in smart contracts.

### CROSS REFERENCE TO RELATED APPLICATIONS

This application claims priority under 35 U.S.C. § 119 to provisional patent application U.S. Ser. No. 63/373,788, filed Aug. 29, 2022. The provisional patent application is herein incorporated by reference in its entirety, including without limitation the specification, claims, abstract, and any figures, tables, appendices, or drawings thereof.

### TECHNICAL FIELD

The present disclosure relates generally to ranking participants, which determines participation in transactions that affects the processing of transactions and recording of the transactions in block computation. A new element in a block is called integrity rank, and every transaction is processed and recorded based on the rules of the integrity rank. Every transaction also has a ranking element, which is made operational through a smart contract that governs the participation of participants.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Blockchain has enormous potential for large-scale improvements and is currently being implemented in various industries because of its features, including traceability, credibility, and transparency. A blockchain consists of a decentralized transaction ledger that is maintained within a distributed network of peer nodes and is immutable and unalterable. The first and most popular application of blockchain is perhaps the Bitcoin cryptocurrency. Bitcoin is followed by Ethereum, which utilizes smart contracts to create a platform for distributed applications. Bitcoin and Ethereum are public networks that are open to anyone and can be considered public permissionless blockchain technology.

In the current world, various major industries, including financial services, healthcare, government, agriculture, and so forth, are trying to implement blockchain technology in their ecosystems. The blockchain's transparency, security, and traceability make it ideal to be applied in the supply chain sector. The management and control of the supply chain have become difficult with globalization and with the vastness of complex systems involved. Blockchain technology helps address some of the challenges of the current supply chain system. For instance, customers often find it difficult to access product data that can facilitate ethical or trustworthy buying or assure product authenticity. Traceability is one of the most important features required in the supply chain system, as it provides consumers with transparency and quality assurance.

Industries are expected to be transparent in their functioning and enhance visibility at the operational and organizational levels. Certificates are issued to improve the trust factor and transparency in the supply chain industry. Even though this has helped improve the overall integrity, recent studies show that consumers still hesitate to trust the products fully. Modern traceability systems either do not encompass a product's entire lifetime within the supply chain, or they operate on closed standards whose functioning is not transparent.

In the supply chain ecosystem, multiple players are involved, including manufacturers, suppliers, transporters, distributors, retailers, consumers, logistics, government agencies, and so forth. The contributions made by each entity in the supply chain system differ, impacting the product's quality. The value of the final product is significantly impacted by all the players involved in its lifecycle.

This supply chain ecosystem will also help in tracing the product back to its source in case it is required. For instance, a product recall is a common practice in the food industry whenever a defect with a particular product is identified. Government agencies such as the Food and Drug Administration (FDA). Food Safety and Inspection Service (FSIS), the U.S. Department of Agriculture, and so forth, will be required to investigate the entire production chain in the case of foodborne or zoonotic outbreaks (“United States Department of Agriculture, Food Safety and Inspection Service,” May 18, 2021). The Center for Disease Control (CDC) estimates Salmonella bacteria cause about 1.35 million infections, 26,500 hospitalizations, and 420 deaths annually in the United States (Information for Healthcare Professionals | Salmonella | CDC). Foodborne infection is the source of most of these illnesses. These outbreaks need to be traced back to the contamination source to provide accurate information to prevent more people from getting sick, prevent similar outbreaks in the future, and identify what steps need to be taken by the public to protect themselves. As per the Department of Health and Human Services, the product recall can currently take up to 300 days, with an average of 57 days). Therefore, the traceability feature of blockchain technology can be of great advantage in the food supply chain in these kinds of situations.

Currently, systems of this nature are centralized structures where reputations are verified, requiring updates by the managers of such systems when nontrivial decisions primarily on security are determined. Such systems require the frameworks to be set up by organizations, and any cross-organization transactions require special arrangements between the two organizations.

Therefore, there is a major deficiency with current blockchain transactions, which is that all transactions are treated with equal ranking. This can be extremely detrimental to achieving business goals within a wide variety of industries since business priorities cannot be implemented.

### SUMMARY

The following objects, features, advantages, aspects, and/or embodiments, are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

An aspect of the present disclosure is a system with integrity-ranked transactions for a supply chain electronic communication system that includes a network electronic interface through which electronic content is received, the electronic content comprising a plurality of transactions for receipt by a plurality of users associated with a plurality of user accounts of the supply chain system, where each transaction has both a blockchain component and a ranking component, at least one memory that comprises a first plurality of memory addresses that are arranged as a plurality of user accounts, each account associated with a user and a second plurality of memory addresses associates the plurality of user accounts with transactions and associated objects, and at least one processor for cooperation with the memory and the network interface, the processor configured to analyze the object in an initial state and the object's current ranking and then determine if a new block and associated object's blockchain needs to be generated as part of the ongoing plurality of transactions occurring within a supply chain electronic communication system.

Another aspect of the present disclosure is integrity-ranked transactions for a supply chain electronic communication system that includes that a user can only modify the object if the integrity level of the user is greater than or higher than the integrity level of the object.

Yet another aspect of the present disclosure is a system with integrity-ranked transactions for a supply chain electronic communication system, where the user at a specific clearance level cannot write data to an object at a higher classification level.

Another feature of the present disclosure is an integrity-ranked transactions for a supply chain electronic communication system where the user can only modify the object if the integrity level of the user is greater than or higher than the integrity level of the object and the user, at a specific clearance level, cannot write data to an object at a higher classification level.

Yet another aspect of the present disclosure is a system with integrity-ranked transactions for a supply chain electronic communication system that includes an initial rank of the user that is determined by an existing user and updated based on the operational characteristics of the user.

Still, yet another feature of the present disclosure is a system with integrity-ranked transactions for a supply chain electronic communication system that includes an initial rank of the object that is determined by an immutable property of the object or the user making the initial rank determination.

Another feature of the present disclosure is a system with integrity-ranked transactions for a supply chain electronic communication system that includes an initial rank of the user that is determined by security principles.

Still, another aspect of the present disclosure is a system with integrity-ranked transactions for a supply chain electronic communication system that includes integrity-ranked smart contracts.

A further feature of the disclosure is a system with integrity-ranked transactions for a supply chain electronic communication system that includes a network electronic interface through which electronic content is received, the electronic content comprising a plurality of transactions for receipt by a plurality of users associated with a plurality of user accounts of the supply chain system, where each transaction has both a blockchain component and a ranking component, at least one memory that comprises a first plurality of memory addresses that are arranged as a plurality of user accounts, each account associated with a user and a second plurality of memory addresses associates the plurality of user accounts with transactions and associated objects, and at least one processor for cooperation with the memory and the network interface, the processor configured to analyze the object in an initial state and the object's current ranking and then determine if a new block and associated object's blockchain needs to be generated as part of the ongoing plurality of transactions occurring within a supply chain electronic communication system that is applied to each function in a supply chain that includes procurement, production, storage, transportation and delivery of the object for optimization of the supply chain.

Still, another feature of the present disclosure is a system with integrity-ranked transactions for a supply chain electronic communication system that includes at least one processor determining at least one of cost, lead time, and quality for the object.

Still yet another feature of the present disclosure is a system that includes objects are selected from the group consisting of actors, stock, supervisors, products, shipments, certificates, and transporters, and subjects are selected from the group consisting of actors smart contracts, supervisors smart contracts, products smart contracts, shipments smart contracts, certificates smart contracts and transporters smart contracts.

Another aspect of the present disclosure is a system that includes at least one processor optimizing the user, or the object based on system-wide performance metrics, wherein the system-wide performance metrics are selected from the group consisting of integrity, quality, cost, and lead time.

An additional feature of the disclosure is a system with the optimized user or optimized object combined with smart contracts that optimizes supply chain operations to provide safety, traceability, and efficiency.

Yet another feature of the method of the present disclosure is a supply chain includes a supply chain in at least one of the following fields of manufacturing, food, agriculture, pharmaceutical, and healthcare to provide safety, traceability, and efficiency.

It is still yet another feature of the method of the present disclosure is for utilizing integrity-ranked transactions in a supply chain electronic communication system that includes generating electronic content is received, the electronic content comprising a plurality of transactions for receipt by a plurality of users associated with a plurality of user accounts of the supply chain system, where each transaction has both a blockchain component and a ranking component with a network electronic interface, utilizing a first plurality of memory addresses that are arranged as a plurality of user accounts, each account associated with a user and a second plurality of memory addresses associates the plurality of user accounts with transactions and associated objects with at least one memory, and analyzing the object in an initial state and the object's current ranking and then determine if a new block and associated object's blockchain needs to be generated as part of the ongoing plurality of transactions occurring within a supply chain electronic communication system with at least one processor that cooperates with the memory and the network interface.

It still another feature of the method of the present disclosure is for utilizing integrity-ranked transactions in a supply chain electronic communication system by determining an initial rank of the user by an existing user and updated based on the operational characteristics of the user.

It is yet another feature of the method of the present disclosure is for utilizing integrity-ranked transactions in a supply chain electronic communication system that further includes applying to both the blockchain component and the ranking component for each function in a supply chain that includes procurement, production, storage, transportation, and delivery of the object for optimization of the supply chain.

In still yet another aspect of the present disclosure is a method for utilizing integrity-ranked transactions in a supply chain electronic communication system that includes utilizing smart contracts with the processor.

Another aspect of the present disclosure is a method for utilizing integrity-ranked transactions in a supply chain electronic communication system that includes optimizing the user or the object based on system-wide performance metrics with the at least one processor optimizing the user or the object based on system-wide performance metrics with the at least one processor, wherein the objects are selected from the group consisting of actors, stock, supervisors, products, shipments, certificates, and transporters and subjects are selected from the group consisting of actors smart contracts, supervisors smart contracts, products smart contracts, shipments smart contracts, certificates smart contracts and transporters smart contracts.

Still, another aspect of the present invention is a method for utilizing integrity-ranked transactions in a supply chain electronic communication system, includes utilizing smart contracts optimizes supply chain operations to provide safety, traceability, and efficiency.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

[The patent or application file contains at least one drawing executed in color. Copies of this patent or patent application publication with color drawing(s) will be provided by the Office upon request and payment of the necessary fee]

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a schematic diagram of the existing blockchain structure;

FIG. 2 is a schematic diagram of an existing blockchain and a new and novel blockchain that includes both the existing blockchain and a rank.

FIG. 3 is a schematic diagram of a transition from an existing blockchain structure to the invention of a blockchain structure with a ranking component.

FIG. 4 is a schematic diagram of a transition from an existing blockchain structure to a proposed blockchain structure that includes both a current rank and a previous rank.

FIG. 5 is a schematic diagram of a proposed blockchain structure that provides a contrast to FIG. 1 of the existing blockchain structure.

FIG. 6 is a schematic diagram of an example operation within this blockchain framework.

FIG. 7 shows a schematic diagram of an example operation within a blockchain framework associated with the system disclosed in this application.

FIG. 8 shows a domain diagram denoting data abstractions associated with a cyber-physical supply chain.

FIG. 9 shows a sequence diagram of product existence associated with a cyber-physical supply chain.

FIG. 10 shows a schematic diagram of a smart contract associated with a cyber-physical supply chain.

FIG. 11 shows a schematic diagram of the interaction between the supply chain actors and the blockchain nodes associated with a cyber-physical supply chain.

FIG. 12 shows a schematic diagram of a smart contracts placement within a cyber-physical supply chain.

FIG. 13 shows a schematic of a progression of integrity through a cyber-physical supply chain.

FIG. 14 shows a schematic of integrity interactions between smart contracts and data structures.

FIG. 15 shows Listing 1, which is a shortened version of the transaction receipt taken from the test blockchain. This receipt shows the output of a function call made to the Products smart contract to create a product sent via a transaction.

FIG. 16 shows Listing 2, which is the transaction receipts for an integrity update.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit the basic operation of the present disclosure unless otherwise indicated.

This invention presents the idea of utilizing blockchain framework as a reputation identification, update, and validation mechanism by integrating the construct of “rank” as utilized in guaranteeing security and privacy goals for confidentiality, integrity, availability, and authorization aspects of any event generated by a transaction among participants (subjects or objects) of a blockchain ecosystem. Such “rank” is partially ordered and presents a dominance relationship, representing different entities participating in transactional events within a cyber-enabled system.

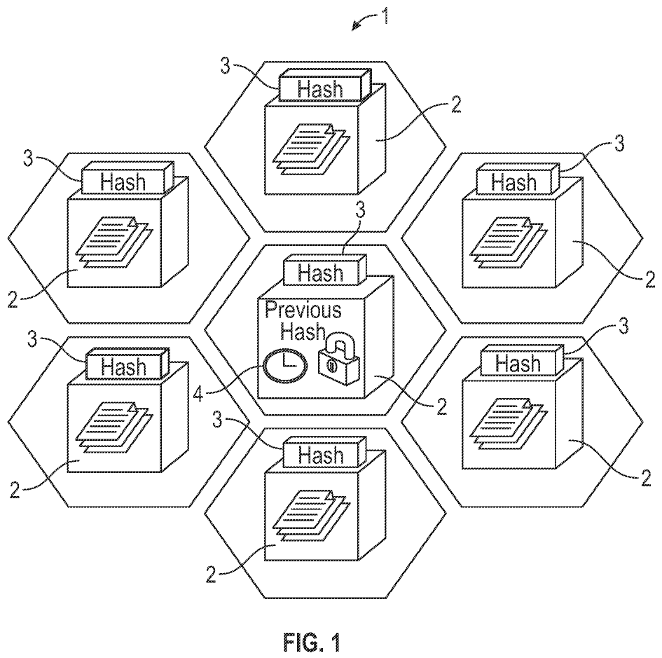

Referring now to FIG. 1, the current blockchain structure is generally indicated by numeral 1, which comprises: 1. Transactions (Ti) represent a new event that requires the creation of a new block that will be integrated into the existing current state of a blockchain: 2. Timestamp (T) represents the relative time the block is created; and 3. Hash (H) of the previous block.

Every blockchain participant has the same information, and every transaction within such a blockchain can be verified independently. There are transactions represented by numerals 2, including a hash 3 and a timestamp 4. Smart contracts logically validate transactions within modern blockchains.

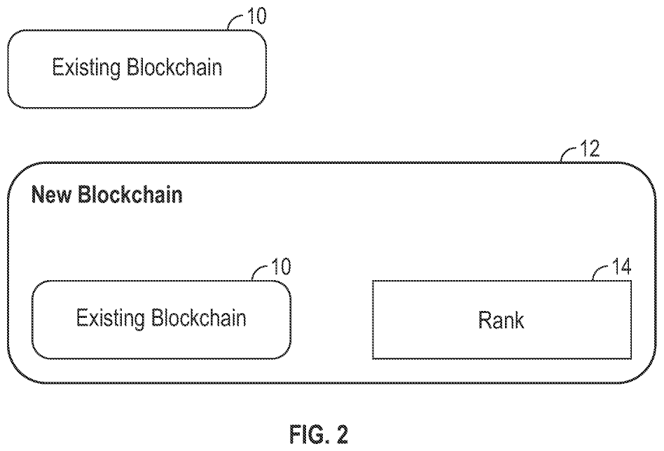

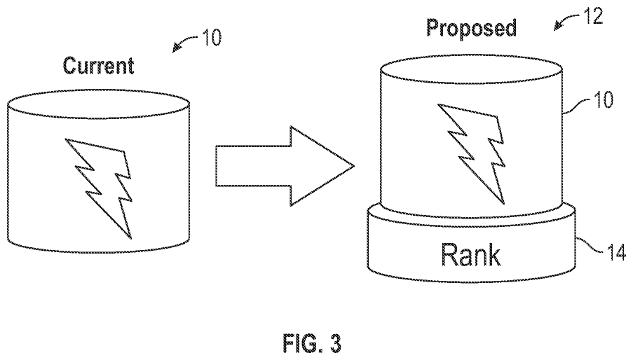

Referring now to FIG. 2, this invention presents the idea of utilizing a blockchain framework as a reputation identification, update, and validation mechanism by integrating the construct of “rank” as utilized in guaranteeing security goals for confidentiality, integrity, availability, and authorization aspects of any event generated by a transaction among participants (subjects or objects) of the blockchain ecosystem. The current blockchain structure is represented by the numeral 10, while the new blockchain structure can be schematically represented by the numeral 12, which includes both the existing blockchain 10 and a rank 14. The transaction structure to accommodate such change is best shown in FIG. 3.

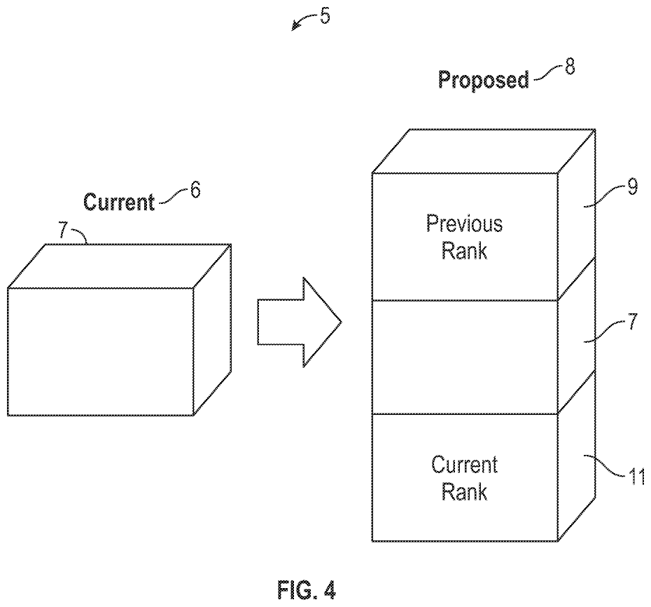

Subsequent changes to the block structure to accommodate a rank-based operation are highlighted in FIG. 4, and generally indicated by numeral 5. The addition of the ranking technique 8 takes advantage of all existing properties of the blockchain 6 indicated by block 7 while adding new capabilities of identifying participant rank for both a previous rank 9 and the current rank 11, verifying the feasibility of a transaction based on security goals as well and recording successful transactional events for future reference. The logic of verification about feasibility is contained within smart contracts, and every transaction bears the stamp of the logical outcome of rank determination.

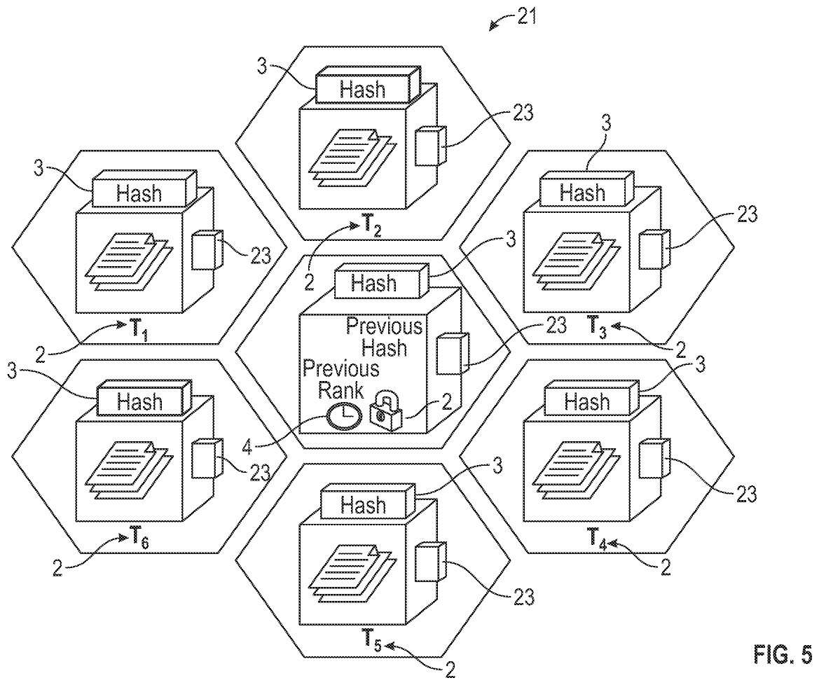

All the changes, when incorporated into the blockchain, would be represented in FIG. 5 and is generally indicated by the numeral 21 and its marked differences from the blockchain as noted in FIG. 1, which includes explicitly the rank 23.

Consequently, this invention creates a transactional event registry that is guided by the feasibility of events based on security, privacy, and operational principles while maintaining the distributed decision-making properties of blockchain architectures along with the verifiability of transactions captured within a block. The transition from this Blockchain technology provides a distributed verifiable structure for a transaction record.

The addition of the ranking technique takes advantage of all existing properties of blockchain while adding new capabilities of identifying participant reputation, verifying the feasibility of a transaction based on security goals as well and recording successful transactional events for future reference.

Currently, alternatives to blockchain are centralized structures where reputations are verified, requiring updates by the managers of such systems when nontrivial decisions primarily on security are determined. Such systems require the frameworks to be set up by organizations, and any cross-organization transactions require special arrangements between the two organizations, thus limited by centralized decision-making.

Modern blockchain technology provides a distributed verifiable structure for a transaction record that is dictated by decisions represented by smart contracts. The integration of ranking within blockchain has the following implications. The first and foremost outcome of is that in any cyber-enabled system with participants identified as Subjects and Objects, every Subject and Object is identified by their blockchain, referred to as identity blockchain.

The integration of ranking within blockchain has the following implications. The first and foremost outcome of that is in any cyber-enabled system with participants identified as Subjects, i.e., “S”, and Objects, i.e., “O”, every Subject and Object is identified by their blockchain, i.e., “BC”, referred to as identity blockchain. An example of such representation is shown as follows:

Subjects(S) are represented in the blockchain (BCS) with a dominance relationship:

Therefore, subjects are represented as S₁−BCₛ₁, S₂−BCₛ₂, and so forth. BCₛ₁<BCₛ₂=BCₛ₃ . . . =BCₛₙ₋₁<BCₛₙ

Objects (O) represented in the blockchain (BCO) with dominance relationship as:

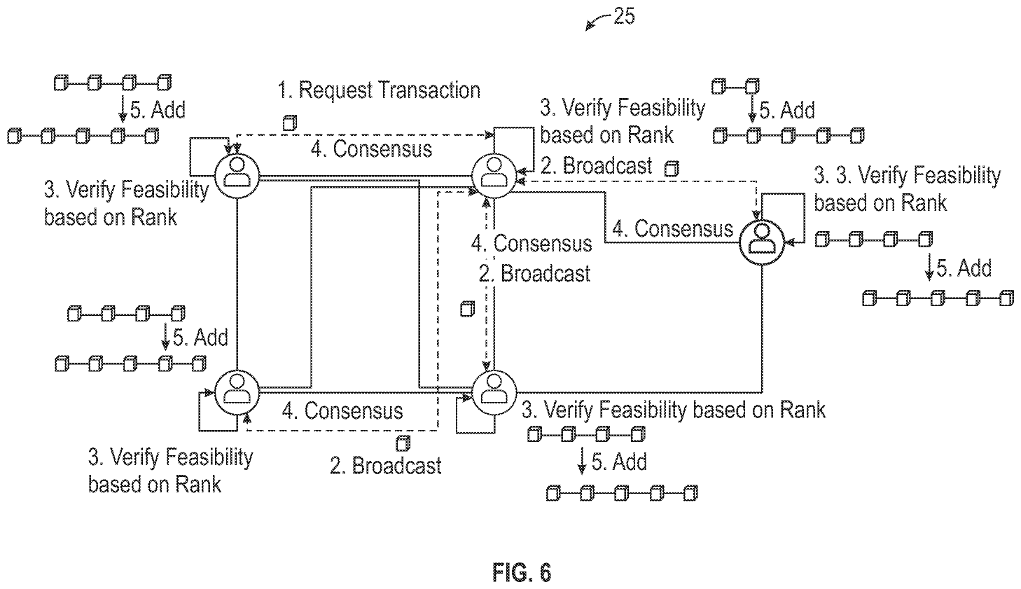

Therefore, Object(s) are represented as O₁−BCₒ₁, O₂−BC_{O2}, and so forth. BC_{O1}-BC_{O2}−BC_{O3} . . . <B_{Com-1}=B_{Com}

| This identity blockchain information is publicly available and can be independently verified by other participants that can be used as to determine any transaction actions. To enable security and privacy considerations for transactional events, all Subjects and Objects participating in blockchain transactions have a unique rank or an array of ranks, each representing unique operational security and privacy constructs within the goals of a blockchain ecosystem. Categorizing Subjects and Objects in such a blockchain ecosystem around ranks would form a lattice-like structure when rankings are organized. Subsequently, every interactive event resulting in a transaction between Subjects and Objects will require an update of all blocks involved in the transaction, identifying the participant/s and the event. Thus, blockchain would function as a mechanism to register an event within a cyber-enabled system of many subjects and objects that are distinguishably different. An example operation with this blockchain framework is shown in FIG. 6 and is generally indicated by the numeral 25.

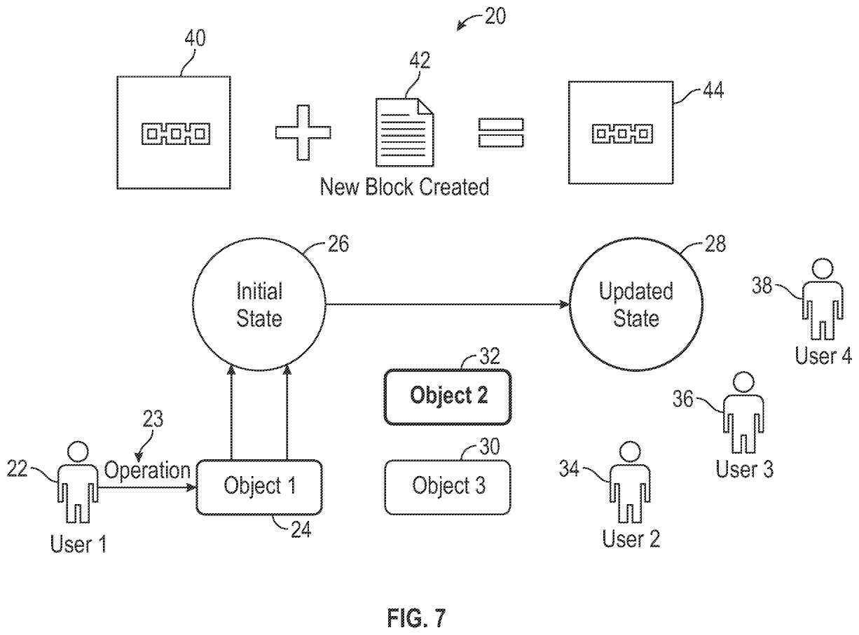

An illustrative, but nonlimiting, example of this blockchain framework is generally indicated by the numeral 20 in FIG. 7. An operation 23 on an object 24 by a first subject 22 results in the change of state of an object from an initial state 26 to an updated state 28 that impacts the rank of the object 24 based on the current rank of the object 24, the current rank of the subject 22 and the rank of any other interacting subject or object for that operation. There is a second user 34, a third user 36, and a fourth user 38 shown in addition to a second object, 32, and a third object 30. Therefore, the initial blockchain 40 plus the creation of a new block 42 results in a new block 44 with the update of an object/s blockchain. Such modification of the rank is guided by the security principles like BiBa's integrity principle or Bell-Lapdula confidentiality principle.

Any operation in the creation of new object(s) from the existing object(s) by a subject results in the creation of a new blockchain 44 for this new object(s) that captures the information of the ingredient object(s), the subject, and the transactional event. The ranking of this new blockchain 44 is determined by the current rank of the objects and subjects with the application of security principles.

Any operation where a subject is added into the blockchain ecosystem is based on an initial rank that is determined by an existing subject within this ecosystem. This rank is subsequently updated with the operational characteristics of the subject.

Any object, when added to this blockchain ecosystem, will be accorded an initial rank determined by some identifiable immutable property of the object and/or a subject determining such rank.

Any operation of changing the rank of a subject by other subject(s) is determined by the rank of the subjects that participate in the operation guided by the security principles involved.

This framework, when applied to the supply chain frameworks, will result in Integrity-rank based transactions and smart contracts to configure a supply chain. For each stage or function in a supply chain, e.g., purchasing or procurement, production, storage, transportation, and delivery, integrity ranking can be employed as an additional performance metric for executing the stage or function, in addition to other performance metrics such as cost, lead time, and quality. Since a supply chain participant (or option in general terms) with a higher integrity rank may (or may not) be more expensive or take longer lead time, there can be a tradeoff between supply chain participants or options. Such tradeoff can be explicitly captured in a supply chain configuration optimization model, which optimizes the option or mode selection decision and the supply chain system-wide performance metrics, including integrity, quality, cost, and lead time.

A decision-support tool integrating integrity-rank based smart contracts and supply chain configuration optimization can be applied in various sectors, including manufacturing, food and agriculture, pharmaceutical, and healthcare. Solutions provided by the tool will provide actionable data-driven decision-support for companies or organizations to implement integrity-rank based transactions in their supply chain operations in an optimal way to achieve safety, traceability, and efficiency.

Tool 20 is able to intelligently prescribe the optimal way to configure a supply chain based on the metrics of each supply participant or option in integrity score, cost, lead time, and quality. That is, when any performance metric of any participant varies dynamically, the optimal configuration will change accordingly, which is not intuitive or practical for a manual process to handle.

Technology is so embedded that the combination of the cyber within the physical world results in the creation of a cyber-physical system. The combination of these cyber-physical systems and supply chain results in the creation of a Cyber-Physical Supply Chain (hereafter. “CPSC”). CPSCs are not merely the sum of distinct parts, but the cohesive functioning of those parts to produce a single system. In order for blockchain to be successfully incorporated into the CPSC, it must be able to extend this cohesive functionality of the physical and cyber realms. There are abstractions used to combine the supply chain environment and a blockchain system, as recited below.

The terms in a CPSC system are as follows: “Products” are defined as all the goods within the supply chain system, and “Actors” are defined as any of the participants in the supply chain that create or handle goods outside of the transportation activities and the Consumer. Actors fall into one of four subcategories. This includes: “Producers”, defined as the Actors that are responsible for creating products. “Distributors” are defined as those Actors that merely act as midpoints for product passing between locations that are sometimes referred to as Warehouse or Distribution nodes. “Processors” are defined as those Actors that use existing products and further process them to produce new products. Finally, “Retailers” are defined as those Actors that make the products in the supply chain available to the Consumer.

“Transporters” are defined as entities responsible for shipping goods between Actors. “Shipment” is defined as a collection of goods to be transported between two Actors via a Transporter. “Certificates” are defined as that used to authorize an Actor and Transporter to handle a specific type of product, e.g., without an organic certificate, an Actor cannot handle products that have an organic type. Finally, “Supervisors” are defined as the entities responsible for creating Actors and Transporters and for issuing certificates to both.

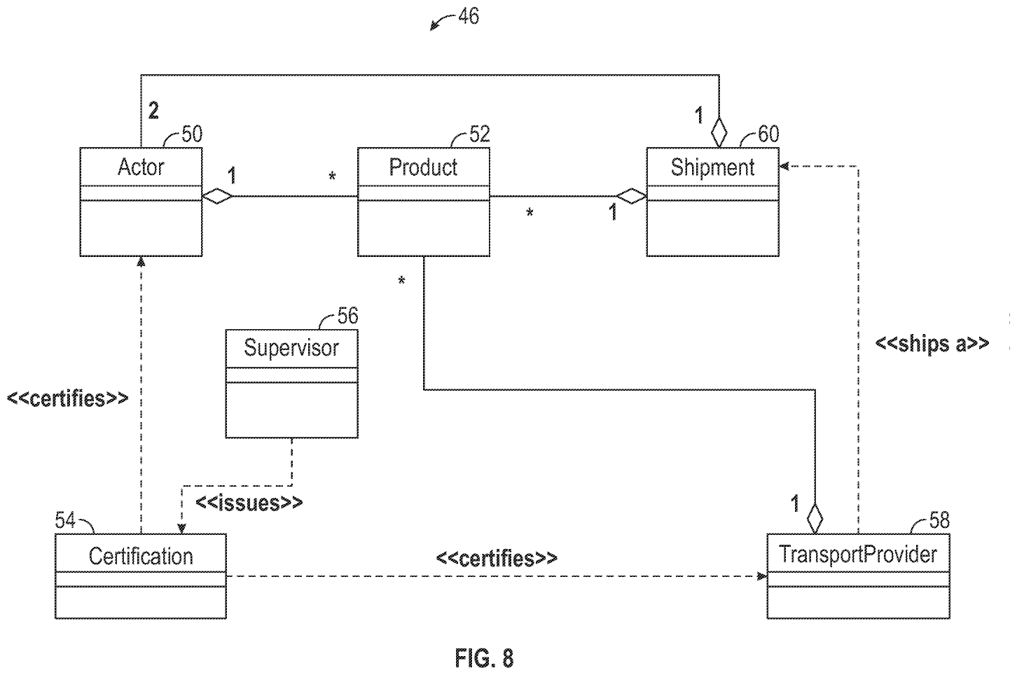

Therefore, instead of merely capturing identifying information of real-world products within a cyber system, entire data structures that serve as digital abstractions of the physical entities need to be created. These digital abstractions are both static and dynamic in nature. The static entities need to house data, and the dynamic entities need to facilitate the creation/modification of the data. The data abstractions used in the creation of this new integrity-scored or ranked system associated with the present invention are denoted in FIG. 8 using a Domain Diagram that is generally indicated by the numeral 46.

Therefore, referring now to FIG. 8, a single Actor 50 can have ownership of multiple Products 52. Before being allowed to have such ownership of a Product 52, the Actor 50 must be certified by possessing a valid Certificate, through Certification 54, which is issued by Supervisors 56. The same Supervisors 56 can also issue Certificates through Certification 54 to TransportProviders 58. TransportProviders 58 are entities that are allowed to transport goods between Actors 50 via a Shipment 60. A Shipment 60 can be created between two Actors 50 only, and for the duration of the Shipment 60, ownership of the Product 52 being shipped is transferred to the TransportProvider 58.

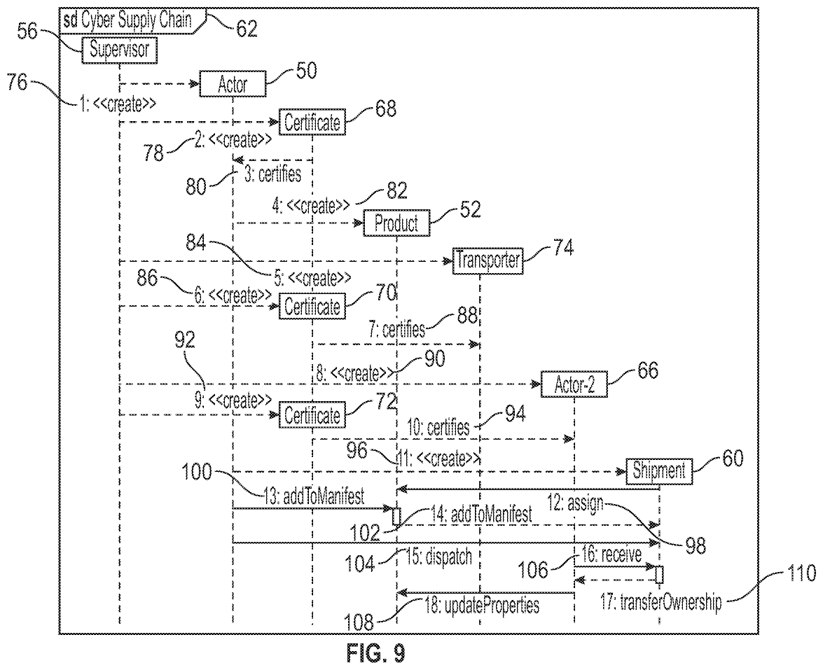

FIG. 8 does not denote the chronological order required in establishing the depicted relationships and is, therefore, a static representation of the relationships between entities. Instead, FIG. 9 uses a UML sequence diagram, generally indicated by the numeral 62, to denote the temporal component at the hand of a use-case scenario. This dynamic depiction captures the events that one would expect within a supply chain to realize the shipment of a product. It includes the creation of the product's parents, the product itself, the certification process, and the shipment and change of ownership.

Referring now to FIG. 9, the first step 76 is that a Supervisor 56 will create an Actor 50. The second step 78 is that once created, the Actor 50 needs a first Certificate 68, which can only be issued by a Supervisor 56. This first Certificate 68 will allow an Actor 50 to work with a particular type of Product 52 in the third step 80 of certifying. The Actor 50 will then be able to create a Product 52 as indicated by the fourth step 82. The only way Product(s) 52 can be moved between Actors 50 is via a Transporter 74, which needs to be created in a fifth step 84 and certified with a Second Certificate 70 in a sixth step 86 to deal with the same product type as the Actors 50 looking to ship Products 52 in a seventh step 88. The Supervisor 56 then can create a second Actor 66 in an eighth step 90 and certify them with a Third Certificate 72 in a tenth step 92. In order for Shipment 60 to take place, the Actor 50 or 66, that is the owner of the Product 52 to be shipped, must create a Shipment 60, in an eleventh step 96, which is in turn assigned to a Transporter 74 in a twelfth step 98. Once a Shipment 60 exists, then the owner of the Product(s) 52 to be shipped can then assign those Product(s) 52 to a Shipment 60, in a thirteenth step 100, which will then place the Product 52 in the Shipment 60's manifest in a fourteenth step 102. The owner of the Product 52 can then mark a Shipment 60 for dispatch, which would close the Shipment 60, in a fifteenth step 104. Then the destined recipient receives the Shipment 60, in a sixteenth step 106. The integrity-based ranking system will transfer the Product 52 ownership from the shipper to the recipient, in a seventeenth step 108. Once the ownership of the Product 52 has been moved to the recipient Actor 50, 66, the Actor 50, 66 may make changes to the properties of the Product 52, in the eighteen step 110. This ownership will be limited to quality and integrity only.

By modeling the static and dynamic aspects of the supply chain environment in this manner, a cyber version is constructed where abstractions are used to persist the physical into the cyber to create a single cohesive system. This persistence is where the blockchain will be used.

The data structures and abstractions referenced above can be used to construct the cyber part of the CPSC system. The framework within which this will be constructed is a set of smart contracts housed within the blockchain.

Blockchain provides a means by which it is possible to create a decentralized ledger that allows for deterministic persistence of immutable transactions that is a system that is not under the control of a single entity, that provides a robust means by which transactions can be recorded, without them ever being edited again. These two core characteristics, immutability, and determinism, make blockchain the perfect means by which a complex trust-based system can be transformed into a trustless system.

An extension of this technology is the idea of adding arbitrary logic in front of a transaction. This arbitrary logic could then be used to control the conditions under which a transaction would be allowed to succeed. Additionally, storing this logic on a decentralized system, such as blockchain, ensures that the characteristics of immutability and determinism are extended to the deployment of the arbitrary logic. This arbitrary logic, can be expressed algorithmically, and these logic algorithms are called smart contracts. If the logic contained within the smart contract is successfully executed, a transaction is persisted on-chain. Once persisted, an immutable record of smart contract execution is created, which forms a perfect historic record.

Smart contracts built on a blockchain can provide surety in the execution of the logic, but not necessarily in the logic of the logic. That is, bad logic could still be compiled and deployed as a valid smart contract. As such, extra care must be taken during the programming to ensure the logic is solid. In traditional Object-Oriented Programing (hereinafter “OOP”), classes contain data (state) and methods to modify the state. Smart contracts follow a similar idea: however, it is abstracted one level higher in the supply chain context.

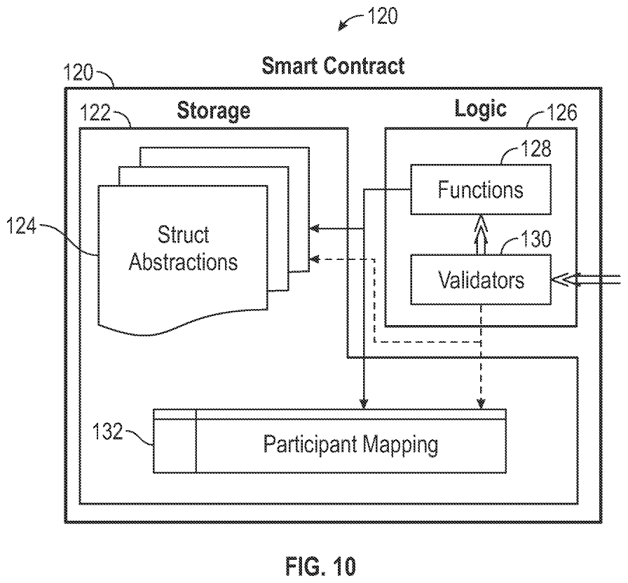

FIG. 10 denotes the smart contract design convention utilized with this invention, generally indicated by numeral 120. However, it is merely an illustrative example and is by no means an exhaustive representation of all the structures within a smart contract. Because of the differences between smart contracts and traditional OOP, a Smart Contract Oriented Programming (hereinafter “SCOP”) approach is utilized with modifications selectively made to standard UMI, diagrams to better explain the SCOP nature of the blockchain system.

A blockchain participant is an account that is uniquely identifiable within the network. Each account corresponds to a single supply chain participant. Therefore, each Actor within the physical supply chain will have a blockchain address (id) unique to them. A participant in a smart contract is the entity denoted by the struct abstraction stored as a key-value pair.

Each contract captures one supply chain entity, e.g., Actors. Within each smart contract 120, there exists state (storage) 122 and logic 126, which controls the state. The only way to modify the state is via logic. Within the storage 122 for each smart contract 120, there are struct abstractions 124 that map to real supply chain participants 132, e.g., in the Actors contracts, each instance of the actors struct abstraction denotes one supply chain actor. Also, in the storage 122 is participant mapping 132. This is a key-value mapping storing the blockchain addresses of the accounts within the network that are considered to be of the same type as the contract, i.e., the Actors participant mapping, stores a key-value list of all the accounts within the blockchain belonging to the Actors.

The logic of the smart contract 120 is indicated by the numeral 126. The entry point for this contract is through the Validators 130. The Validators 130 contain rules controlling which participants are allowed to access which logic, resulting in changes to the storage. When a function call is made to a smart contract 120, the conditions of the Validators 130 must be met before the actual Function 128 can be executed. Validators 130 also cannot make changes to the state and can merely read the current contract state. Noniterable mappings can be used as well. This means that the Validator 130 can only look up the key-value pair associated with the caller's address and cannot iterate over other key-value pairs. Since smart contracts are capable of making calls to each other. Validators 130 of one smart contract can call Functions 128 within another smart contract, i.e., they can cross-validate. Again, the Validators 130 can only make calls to Functions 128 that read the state. This becomes useful in ensuring the integrity of the state of each smart contract 120.

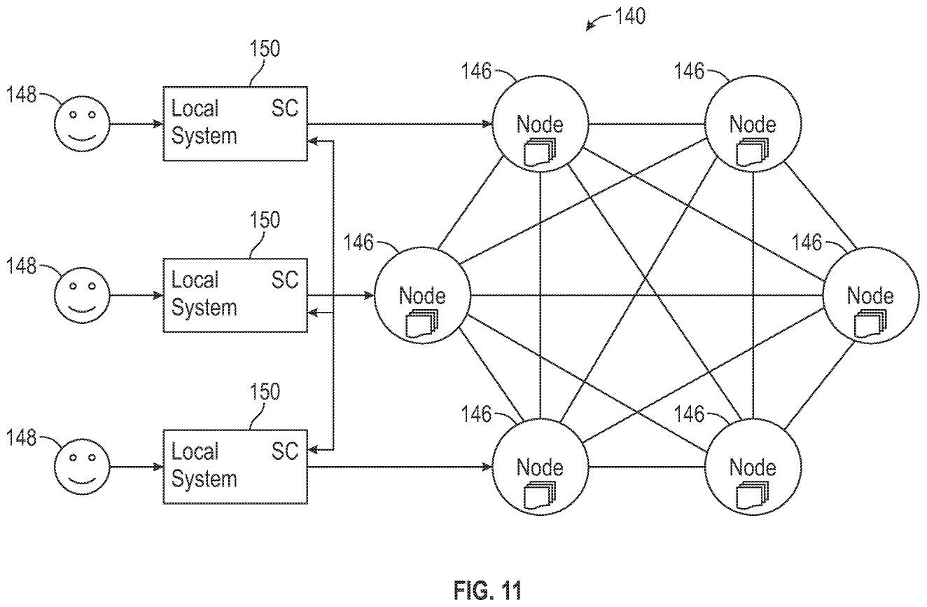

The interaction between the supply chain actors and the blockchain nodes is depicted in FIG. 11 and is generally indicated by the numeral 140. Supply chain Actors 148 will still interact with their local supply chain system 150; the difference comes in that these local supply chain systems 150, each are connected to a blockchain node 146. Each blockchain node 146, in-turn, participates in the consensus mechanism by which transactions are added to the historic record of the entire network and itself contains a full copy of the historic record of the blockchain.

FIG. 11 only shows the high-level interaction between actors 148 and the blockchain. The interaction between the local supply chain system and the broader network is where smart contracts would fit in. Being programs themselves, these smart contracts can represent any arbitrarily complex logic: however, since these programs reside on-chain, their results persist on-chain in the form of transactions.

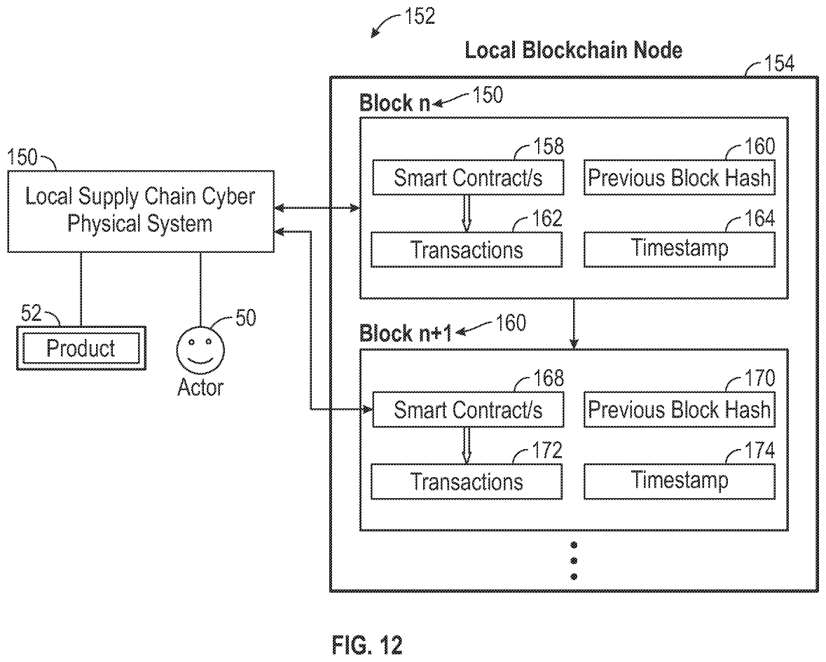

FIG. 12 presents a more detailed breakdown of how Actor 50 and Physical Products 52 would interact with the CPSC blockchain system, as generally indicated by the numeral 152. Actor's 50 would interact through their own local Cyber Physical System 150. This local Cyber Physical System 150 would also house a blockchain node 154. This node 154 facilitates an Actor's 50 interaction with the larger blockchain. Contained within each node 154 is a full copy of the blockchain. Each action of the Actor 50 in the physical space co-equally results in an action within the blockchain space on the UML sequence diagram 62, as depicted in FIG. 9. This action is stored in the blockchain in the form of transactions contained within each block 156. These transactions are created by the Smart Contracts 158, which are also housed within the blockchain.

The immutability of blockchain ensures that these transactions that are persisted, will remain persisted and can never be modified. The determinism in execution ensures that the Smart Contracts 158 will always produce the same output for the same input. However, this does not mean that logic errors are subverted: poorly designed Smart Contracts 158 can still exist within the blockchain. Therefore, care must be taken when designing these blockchains. Block n 156 includes the smart contract(s) 158, the previous block hash 160, transactions 162, and a timestamp 164. The next block in the chain, i.e., n+1, 166, also has smart contract(s) 168, a previous block hash 170 that receives input from the transactions 162 of Block n 156, transactions 172, and a timestamp 174.

A CPSC blockchain system requires an integrity modeling framework. An illustrative, but nonlimiting, example of an integrity modeling framework is the Biba Integrity model. The Biba integrity model is a widely accepted model used in the world of computer science to manage and govern integrity.

The Biba model works by categorizing entities into two cohorts, subjects, and objects. Subjects are considered to be active entities that can make calls to processes and induce data flow. Objects are passive entities handled by subjects. Consider the example of office space. There are workers in the space (subjects) that handle documents (objects). To manage the integrity flow between subjects and objects, Biba assigns to each object and subject an integrity level. These integrity levels and the interaction between subjects are then defined by three key rules or axioms: 1. Simple integrity property, which is that a subject with a certain integrity level must not read data at a lower integrity level: 2. Star integrity property, which is that a subject with a certain integrity level must not write or contribute towards data with a higher integrity; and 3. Invocation property is when a subject cannot use a process to request data of a higher integrity level.

The way that integrity management can be incorporated into a blockchain supply chain system is two-fold. The first is the progression of the integrity of entities, and the second is the nature of the interactions between entities.

Participants and goods can also be abstracted within the supply chain as subjects and objects, respectively. Subjects are any participants in the supply chain with an active role, that is, actors, supervisors, transporters, and so forth. Objects are goods and passive structures such as certifications and products. Each of these can be given an integrity level. As the objects move between subjects, the integrity rules could be enforced, and the integrity of objects could be further updated.

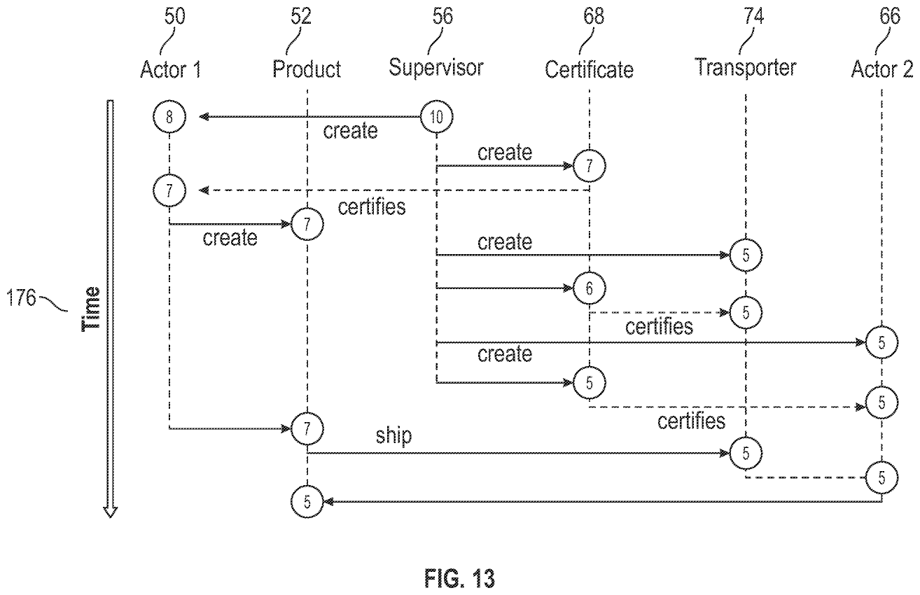

This is perhaps best explained using a diagrammatic representation as in FIG. 13, which is a simple supply chain example that compares to the example shown in FIG. 9. Each of the circles denotes the integrity level at that given point in time and the action. For an example, a Supervisor of Integrity level 10 creates an Actor of integrity level 8. The integrity here is depicted as being a distinct integer value on a ten-point scale: however, it can be modeled using a continuous real value as well. A First Actor 50, Product 52, Supervisor 56, Certificate 68, Transporter 74, and Second Actor 66 are shown in relationship to time 176 with both an integrity level and the creation or certification process that proceeds it.

TABLE 1
Ranking of Entities

| | | | Product | Certificate | Actor | Supervisor | Transporter | Shipment |
|---|---|---|---|---|---|---|---|---|
| | | Integrity | 1 | 2 | 3 | 4 | 5 | 6 |
| Entity | I, j | Variable | p | c | a | su | t | s |
| Product | 1 | p | URS | ≤ | ≤ | ≤ | ≤ | ≤ |
| Certificate | 2 | c | ≥ | URS | ≥ | ≤ | ≥ | ≥ |
| Actor | 3 | a | ≥ | ≤ | URS | ≤ | ≥ | ≥ |
| Supervisor | 4 | su | ≥ | ≥ | ≥ | URS | ≥ | ≥ |
| Transporter | 5 | t | ≥ | ≤ | ≥ | ≤ | URS | ≥ |
| Shipment | 6 | su | ≥ | ≤ | ≤ | ≤ | ≤ | URS |

The integrity management supposes that if the rules in Table I are enforced at a transactional level along the entire path of a product, then that product and associated entities (at least within the scope of that path) can be said to be integrity compliant. This supposition can be formulated and subsequently proven using prepositional logic proof.

If Aᵢⱼ denotes the integrity rule between entity i and j in Table 1, e.g., A_{1,2}=(p≤c), Let Z denote the integrity compliant outcome such that if Aᵢⱼ⇒Z holds true, then the interaction between entities i & j is said to be integrity compliant.

A pathway is made up of a progression of transactions between entities, and the supposition is that if each transaction in the pathway is compliant with the integrity ranking in Table 1 under Equation 1 shown below, then the entire pathway of transactions can be considered to be integrity compliant as well as shown in Equation 2 below.

$$( {A}_{1 , 1} ⟹ Z ) ⋀ ( {A}_{1 , 2} ⟹ Z ) ⋀ … ⋀ ( {A}_{m , n} ⟹ Z ) \qquad Equation 1$$

$$( {A}_{1 , 1} ⋀ {A}_{1 , 2} ⋀ … ⋀ {A}_{m , n} ) ⟹ Z \qquad Equation 2$$

To show the possibility of Equations 1 and 2, this Equation needs to be proven:

$$( ( {A}_{1 , 1} ⟹ Z ) ⋀ 〈 {A}_{1 , 2} ⟹ Z ) ⋀ … ⋀ ( {A}_{m , n} ⟹ Z ) ) ⋀ ( {A}_{1 , 1} ⋀ {A}_{1 , 2} ⋀ … ⋀ {A}_{m , n} ) ⟹ Z ) \qquad Equation 3$$

This proof is presented in a Fitch-style proof below:

TABLE 2

| 1 (A_{1,1} ⇒ Z) ∧ (A_{1,2} ⇒ Z) ∧ ... ∧ (A_{m,n} ⇒ Z) | |
|---|---|
| 2 (A_{1,1} ∧ A_{1,2} ∧ ... ∧ A_{m,n}) ⇒ Z | |
| 3 A_{1,1} ∧ A_{1,2} ∧ ... ∧ A_{m,n} | ∧E, 2 |
| 4 A_{1,1} | ∧E, 3 |
| 5 A_{1,1} =⇒ Z | ∧E, 1 |
| 6 Z | modus ponens, 4, 5 |
| 7 (A_{1,1} ∧ A_{1,2} ∧ ... ∧ A_{m,n}) =⇒ Z | ∧I, 3, 6 |
| 8 ((A_{1,1} =⇒ Z) ∧ (A_{1,2} =⇒ Z) ∧ ... ∧ (A_{m,n} =⇒ Z)) | |
| =⇒ ((A_{1,1} ∧ A_{1,2} ∧ ... ∧ A_{m,n}) => Z) | ∧I, 1, 7 |

9 QED

Therefore, given the above, it can be said that if the integrity interactions between two ranked entities can be enforced along the entire pathway of that entity's transactions, then the path of interactions itself is integrity compliant. It should, however, be noted that this proof holds only for valid pathways, which consist of valid transactions. This ranking system will, therefore, by design does, not allow invalid pathways or transactions to take place within the blockchain environment.

The second part of integrity management within this ranking system disclosed in this patent application is the nature of the transactions themselves. In the Biba model, the interactions between entities are grouped under one of three terms: 1. Observe, which is the action of viewing information. Observation also includes the idea that the state of the observer may be changed as a result of the observation action: 2. Modify, which is changing an object in a manner such that the change is discernible through observation; and 3. Invoke, which is a request from one subject to another subject to perform either observation or modification operation.

The current ranking system of this invention is constructed using smart contracts that house data abstractions. These smart contracts perform modifications to these data abstractions through transactions. It is, therefore, important that the nature of these transactions between smart contracts and data abstractions is also mapped out and considered in the design of the system prototype.

Table 3 below shows these interactions. In this table “0” denotes observe, and “m” denotes modify. The first part of the table shows the interaction between smart contracts (subjects) and the data abstractions (objects). The second part shows the invocations between smart contracts. Smart contracts may need to make modifications or observations to/of data stored within other smart contracts.

TABLE 3
Subject and object interactions

| | | | | | |
|---|---|---|---|---|---|
| Actors | Products | Shipments | Transporters | Certificates | Supervisors |
| SC | SC | SC | SC | SC | SC |

Subjects

| | | | | | | | |
|---|---|---|---|---|---|---|---|
| Objects | Actor | E | o | o | o | o | — |
| | Actor Stock | E | o, m | o, m | — | — | — |
| | Product | — | E | o, m | — | — | — |
| | Shipment | — | — | E | — | — | — |
| | Transporter | — | — | o | E | o | — |
| | Certificate | — | o | o | — | E | — |
| | Supervisor | o, m | — | — | o, m | o, m | E |

Invocations

| | | | | | | | |
|---|---|---|---|---|---|---|---|
| Subjects | Actors SC | — | — | — | — | — | o |
| | Products SC | o: Actor; o, m: | — | — | — | o | — |
| | | Actor Stock | | | | | |
| | Shipments SC | o: Actor; o, m: | o, m | — | o | o | — |
| | | Actor Stock | | | | | |
| | Transporters SC | o: Actor | — | — | — | — | o |
| | Certificates SC | o: Actor | — | — | o | — | o |

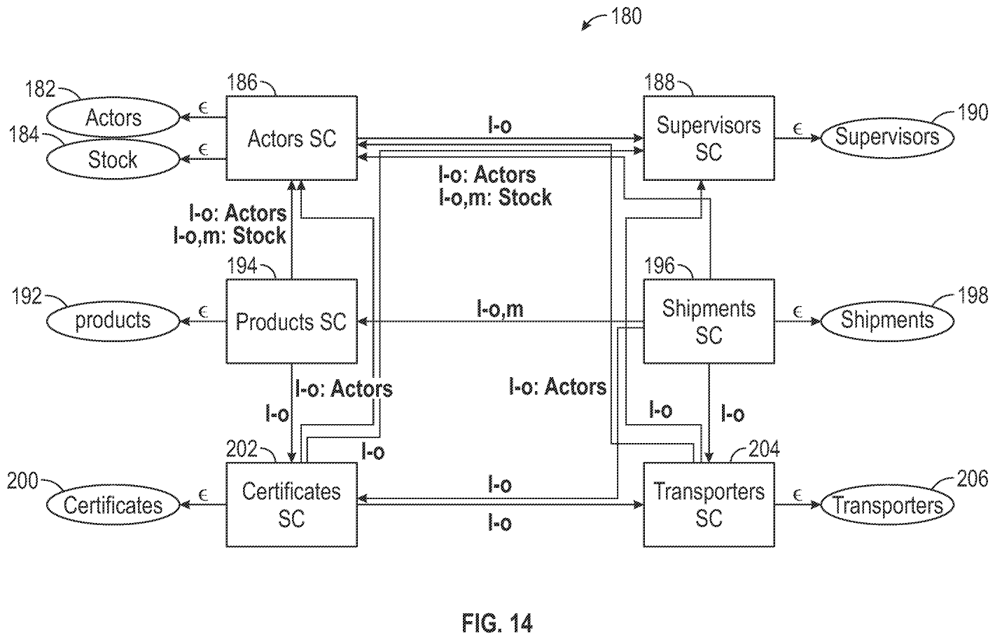

The contents of Table 3 can be depicted diagrammatically as well as in FIG. 14. FIG. 14 9 and Tables 2 and 3 can be utilized to create a prototype of a system with an integrity framework representative of the supply chain environment and is generally indicated in FIG. 14 by numeral 180.

Objects include Actors 182, Stock 184, Supervisors 190, Products 192, Shipments 198, Certificates 200, and Transporters 206, while Subjects include Actors smart contracts 186, Supervisors smart contracts 188, Products smart contracts 194, Shipments smart contracts 196, Certificates smart contracts 202 and Transporters smart contracts 204.

This integrity framework 180, combined with the blockchain CPSC, forms a decentralized blockchain traceability system with integrity management.

One illustrative, but nonlimiting example is to utilize Ethereum in the development tool-chain and not some type of platform-specific solution. Two main results to look for would-be product creation, which shows how a blockchain can be used to create provenance information for supply chain activities, and integrity updating, which shows how integrity modeling can be combined with blockchain. Ethereum is only one illustrative example of a tool. Another would be Hyperledger Fabric CA, among a host of numerous other possibilities.

### Product Creation Includes:

1. A physical supply chain Actor will make a call to the integrity modeling ranking structure system to create a product. Using a graphical user interface, the Actor will provide all the necessary input.
2. The integrity modeling ranking structure system will take the provided input and create a blockchain transaction. The transaction will be directed from the Actor's blockchain account (within the integrity modeling structure system) and will be routed to the Products Smart Contract Account.
3. Once the transaction has been submitted, an Ethereum miner will process the transaction and execute the necessary smart contract code.
4. The outcome of the transaction is then recorded in a Transaction receipt, and the state changes resulting from the transaction are persisted in the blockchain.

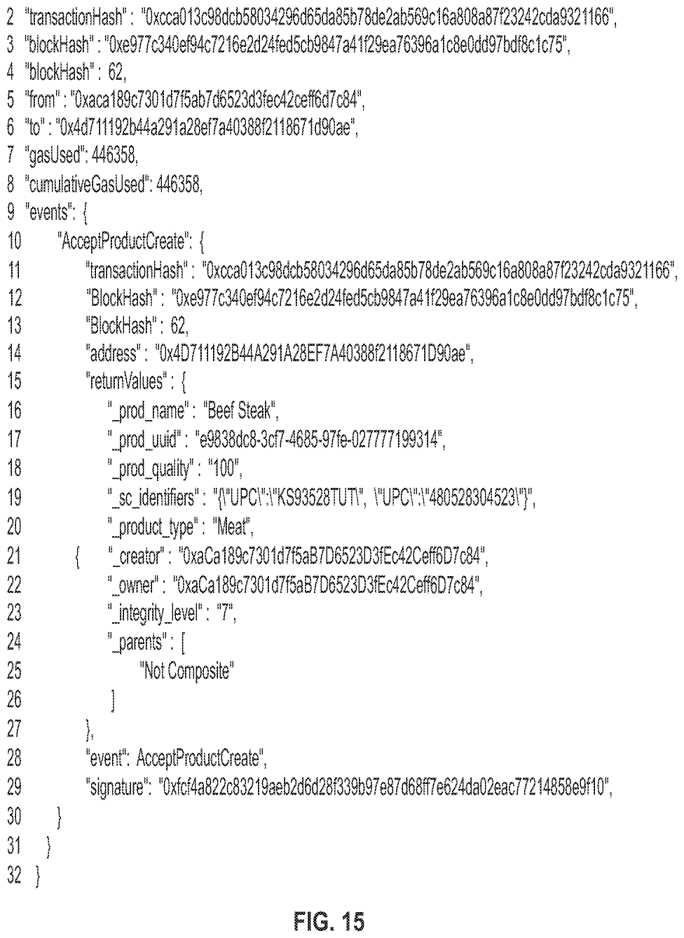

FIG. 15 is an exemplary transaction receipt taken from the test blockchain. This receipt shows the output of a function call made to the Products smart contract to create a product sent via a transaction.

Listing 1 is made up of several parameters that provide important information about the blockchain and the nature of the transaction. This includes:
1 transactionHash, which is the hash of the transaction this receipt corresponds to:
2. blockHash, which is the hash of the mined block the transaction is contained in:
3. blockNumber, which is the block number of the block the transaction is contained in:
4, from, which is the address of the function caller: in this case, the caller is the Actor that created the product:
5, to & address, which is the address of the smart contract account corresponding to the Product(s) smart contract:
6 gas Used & cumulativeGas Used, which is the transaction cost; and
7, events, which is what Ethereum allows for the creation of custom events. These are messages whose structure is programmed into the smart contract. Front-ends can listen for these events and perform actions accordingly, e.g., update a digital display.

The information depicted in Listing 1 is stored on the blockchain and can be accessed by any blockchain participant. This information can be retrieved and used to create successive timelines of product existence, and it can also be used for audit purposes. Each blockchain represents transaction costs differently. Transactions in Ethereum incur a gas cost, representing the cost for the execution of a transaction on the Ethereum network.

By storing this information within a smart contract-based blockchain, the characteristics of immutability and determinism are extended to this information. Immutability is where blockchain provides a perfect historic record that is stored immutably. This means it can never change, once it is stored. In the supply chain, storing product provenance in an immutable manner creates a perfect historic record of the provenance data itself. Determinism is where the data depicted in the transaction receipt in Listing I was created by a smart contract. Smart contracts are themselves deterministic, and so are their outputs. This means that the only way the information could have been generated is if the smart contract was executed in the intended manner.

The extension of determinism and immutability can also be applied to integrity modeling. A formalized integrity modeling structure whose rules are enforced via intelligent contracts would allow for the creation of integrity timelines. Listing 2 depicts the integrity process that is executed whenever a product is received from a shipment. This listing depicts three receipt stubs, all resulting from a single transaction call.

The process that produced these outputs is as follows: 1. An Actor received a shipment of goods. Upon receipt, the actor makes a call to the system to mark the shipment as being received: 2. Once received, the Actor will start to take ownership of their goods sequentially, and a new transaction is fired for each product: 3. Once the ownership has been updated, the new owner, the recipient Actor, can make changes to the product's quality parameter, which for illustrative purposes only can be an integer value between 0 and 100; and 4. During the change of ownership, the smart contract will also update the integrity of the product should it be required where this integrity update is automatic.

In Listing 2 the “logIndex”: 0 object denotes the ownership transferal. The “logIndex”: 1 object denotes the receipt stub for the quality update, and “logIndex”: 2 depicts the receipt stub for the automatic integrity update performed as part of the ownership update.

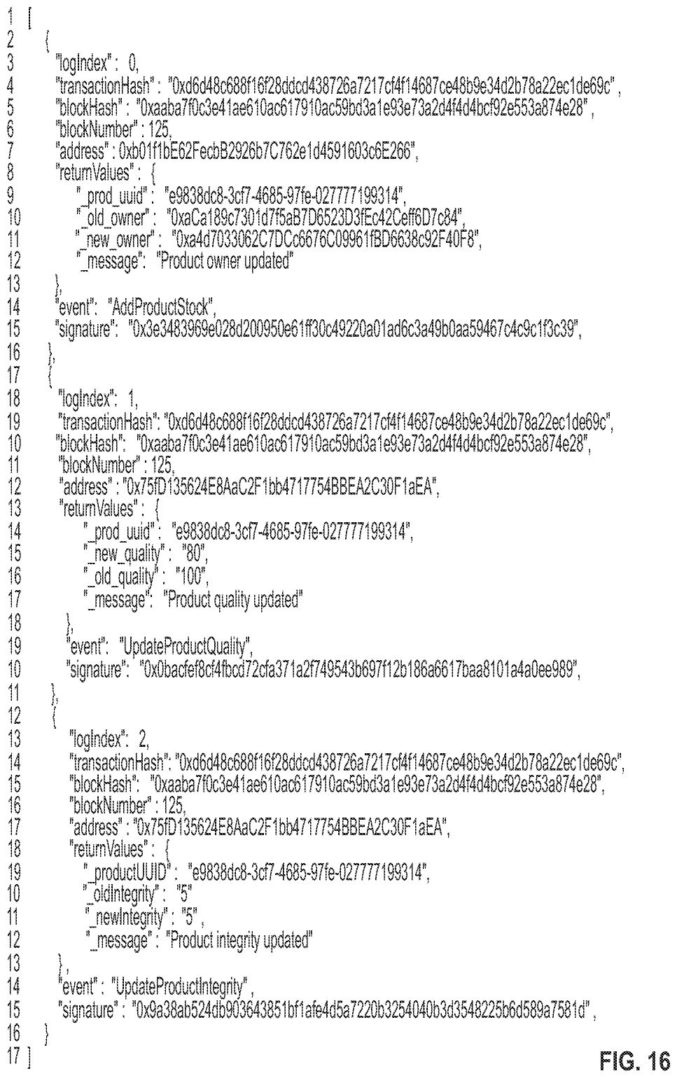

FIG. 16 is Listing 2, which is a transaction receipt for integrity update.

The combination of provenance and integrity timelines creates a more holistic picture of the history of a product and how the movement of the product through the supply chain affected the product. The integrity modeling also presents a mathematical way in which the trust given to products and their provenance can be quantified.

Supply chain traceability is, has, and most probably will be a very active field to improve the traceability of products and the trust in the information provided. The advent of blockchain technology has proven to be a valuable development opportunity and, together, can be seen as the next generation of technological advancement. There are three areas of focus for designing a blockchain-based supply chain traceability system: 1. A supply chain traceability system benefits from decentralization and increased transparency. Supply chain certifications are also a valuable tool, provided the process of issuance is itself transparent. 2. Blockchain technology is designed to provide an immutable historic record that is created in a deterministic manner. Smart contracts further augment the blockchain ability by providing increased automation and the capturing of arbitrary logic. 3. Trust within the supply chain environment can be improved through the usage of integrity modeling.

A Cyber-Physical Supply Chain includes structures used to persist the physical supply chain into the cyber realm by providing a design convention by which blockchain technology can be used to persist these structures into the blockchain. The culmination of this resulted in the creation of a Blockchain CPSC system. In addition, integrity modeling, specifically Biba Integrity modeling, could be used to address the question of trust. The integrity framework provides a means by which an integrity score can be applied to all entities within the CPSC. This integrity score changes based on a very specific set of rules that are enforced using Smart Contracts on the blockchain. This integrity framework allows for the third focus statement to be addressed and also augments the solution to the first two focus statements.

In summary, when applied to the supply chain frameworks, this framework will result in Integrity-rank based transactions and smart contracts to configure a supply chain. For each stage or function in a supply chain, e.g., purchasing or procurement, production, storage, transportation, and delivery, integrity ranking can be employed as an additional performance metric for executing the stage or function, in addition to other performance metrics such as cost, lead time, and quality. Since a supply chain participant (or option in general terms) with a higher integrity rank may (or may not) be more expensive or take longer lead time, there can be a tradeoff between supply chain participants or options. Such tradeoff can be explicitly captured in a supply chain configuration optimization model, which optimizes the option or mode selection decision and the supply chain system-wide performance metrics, including integrity, quality, cost, and lead time. A decision-support tool integrating integrity-rank-based smart contracts and supply chain configuration optimization can be applied in various sectors, including manufacturing, food and agriculture, pharmaceutical, and healthcare. Solutions provided by the tool will provide actionable data-driven decision-support for companies or organizations to implement integrity-rank-based transactions in their supply chain operations in an optimal way to achieve safety, traceability, and efficiency.

The smart contracts thereby represent any operation on an object/s by a subject resulting in the change of state of the object, which impacts the rank of the object based on the current rank of the object, the current rank of the subject, and the rank of any other interacting subject or object for that operation. If such an operation is feasible, a transaction is generated, resulting in the creation of a new block that will be integrated into the existing blockchain with an update to the resulting object/s's rank post such an event. Such modification of the rank can be guided by the security, privacy, and operational principles for rank-based operations like BiBa's integrity principle or Bell Lapdula confidentiality principle, or any principle that has an algorithmic update of rank-based operations.

Any operation in the creation of new object/s from existing object/s by the subject results in the creation of a new block representing this event of the creation of this new object/s based on the ranking information of the ingredient object/s, the rank of the subject and the operational feasibility of the transactional event. The ranking of this new block in the subsequent blockchain is determined by the current rank of the object/s and subject/s with the algorithmic limitations imposed by the application of security, privacy, and operational principles.

Any operation where a subject is added to the blockchain ecosystem is determined by an initial rank determined by an existing subject within this ecosystem. This rank can be subsequently updated with the operational characteristics of the subject.

When added to this blockchain ecosystem, any object will be accorded an initial rank determined by some identifiable immutable property of the object and/or a subject determining such rank.

Any operation of changing the rank of a subject by another subject/s is determined by the rank of the subjects that participate in the operation guided by the security principles involved.

The tool can intelligently prescribe the optimal way to configure a supply chain based on the metrics of each supply participant or option in integrity score, cost, lead time, and quality. That is, when any performance metric of any participant varies dynamically, the optimal configuration will change accordingly, which is not intuitive or practical for a manual process to handle.

From the foregoing, it can be seen that the present disclosure accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 4
List of Reference Characters

| | |
|---|---|
| 1 | Current blockchain structure |
| 2 | Transaction |
| 3 | Hash |
| 4 | Timestamp |
| 5 | Block structure layout |
| 6 | Current Bock chain properties |
| 7 | Block |
| 8 | Ranking technique |
| 9 | Previous rank |
| 10 | Existing blockchain |
| 11 | Current rank |
| 12 | New blockchain |
| 14 | Rank |
| 20 | Blockchain framework |
| 21 | Integrity ranked blockchain structure |
| 22 | First subject |
| 23 | Rank |
| 24 | Object |
| 25 | Example operation with blockchain framework |
| 26 | Initial state |
| 28 | Updated state |
| 30 | Third object |
| 32 | Second object |
| 34 | Second user |
| 36 | Third user |
| 38 | Fourth user |
| 40 | Initial blockchain |
| 42 | New block |
| 44 | New blockchain |
| 46 | Domain Diagram |
| 50 | Actor |
| 52 | Product |
| 54 | Certification |
| 56 | Supervisor |
| 58 | TransportProviders |
| 60 | Shipment |
| 62 | UML sequence diagram |
| 64 | Second Supervisor |
| 66 | Second Actor |
| 68 | First Certificate |
| 70 | Second Certificate |
| 72 | Third Certificate |
| 74 | Transporter |
| 76 | First step of creating Actor |
| 78 | Second step of creating First Certificate |
| 80 | Third step of certifying |
| 82 | Fourth step of creating a Product |
| 84 | Fifth step of creating a Product for the Transporter |
| 86 | Sixth step of creating a Second Certificate |
| 88 | Seventh step of providing certification |
| 90 | Eighth step of creating a Second Actor |
| 92 | Ninth step of creating a Third Certificate |
| 94 | Tenth step of certifying the Second Actor |
| 96 | Eleventh step of creating a Shipment |
| 98 | Twelfth step of assigning a Shipment to a Transporter |
| 100 | Thirteenth step of assigning Products to Shipment |
| 102 | Fourteenth step of adding Products to the Shipment's manifest |
| 104 | Fifteenth step of marking a Shipment for dispatch and close the |
| | Shipment |
| 106 | Sixteenth step of the destined recipient receiving the Shipment |
| 108 | Seventeenth step of transferring ownership from the shipper to the |
| | recipient |
| 110 | Eighteenth step of the recipient Actor updating the properties of |
| | the Product upon ownership. |
| 120 | Smart contract design convention |
| 122 | Storage |
| 124 | Struct Abstractions |
| 126 | Logic |
| 128 | Functions |
| 130 | Validators |
| 132 | Participant Mapping |
| 140 | Interaction between the supply chain actors and the blockchain |
| | nodes |
| 142 | Actors |
| 144 | Local Smart Contract System |
| 146 | Blockchain Nodes |
| 148 | Supply chain Actors |
| 150 | Local supply chain system |
| 152 | Detailed breakdown of how an Actor and Physical Products would |
| | interact with the CPSC blockchain system |
| 154 | Local blockchain node |
| 156 | Block n |
| 158 | Smart Contract(s) |
| 160 | Previous Block Hash |
| 162 | Transactions |
| 164 | Timestamp |
| 166 | Block n + 1 |
| 168 | Smart Contract(s) |
| 170 | Previous Block Hash |
| 172 | Transactions |
| 174 | Timestamp |
| 176 | Time |
| 180 | Integrity interactions between smart contracts and data structures |
| 182 | Actors |
| 184 | Stock |
| 186 | Actors smart contracts |
| 188 | Supervisors smart contracts |
| 190 | Supervisors |
| 192 | Products |
| 194 | Products smart contracts |
| 196 | Shipments smart contracts |
| 198 | Shipments |
| 200 | Certificates |
| 202 | Certificates smart contracts |
| 204 | Transporters smart contracts |
| 206 | Transporters |

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context. The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A system with integrity-ranked transactions for a supply chain electronic communication system comprising:
a network electronic interface through which electronic content is received, the electronic content comprising a plurality of transactions for receipt by a plurality of users associated with a plurality of user accounts of the supply chain system, where each transaction has both a blockchain component and a ranking component:
at least one memory that comprises a first plurality of memory addresses that are arranged as a plurality of user accounts, each account associated with a user and a second plurality of memory addresses associates the plurality of user accounts with transactions and associated objects: and
at least one processor for cooperation with the memory and the network interface, the processor configured to analyze the object in an initial state and the object's current ranking and then determine if a new block and associated object's blockchain needs to be generated as part of the ongoing plurality of transactions occurring within a supply chain electronic communication system.

2. The system with integrity-ranked transactions for a supply chain electronic communication system according to claim 1, wherein the user can only modify the object if the integrity level of the user is greater than or higher than the integrity level of the object.

3. The system with integrity-ranked transactions for a supply chain electronic communication system according to claim 1, wherein the user at a specific clearance level cannot write data to an object at a higher classification level.

4. The system with integrity-ranked transactions for a supply chain electronic communication system according to claim 1, wherein the user can only modify the object if the integrity level of the user is greater than or higher than the integrity level of the object and the user, at a specific clearance level, cannot write data to an object at a higher classification level.

5. The system with integrity-ranked transactions for a supply chain electronic communication system according to claim 1, further comprising an initial rank of the user that is determined by an existing user and updated based on operational characteristics of the user.

6. The system with integrity-ranked transactions for a supply chain electronic communication system according to claim 1, further comprising an initial rank of the object that is determined by an immutable property of the object or the user making the initial rank determination.

7. The system with integrity-ranked transactions for a supply chain electronic communication system according to claim 1, further comprising an initial rank of the user that is determined by security principles.

8. The system with integrity-ranked transactions for a supply chain electronic communication system according to claim 1, further comprising integrity ranked smart contracts.

9. A system with integrity-ranked transactions for a supply chain electronic communication system comprising:
a network electronic interface through which electronic content is received, the electronic content comprising a plurality of transactions for receipt by a plurality of users associated with a plurality of user accounts of the supply chain system, where each transaction has both a blockchain component and a ranking component:
at least one memory that comprises a first plurality of memory addresses that are arranged as a plurality of user accounts, each account associated with a user and a second plurality of memory addresses associates the plurality of user accounts with transactions and associated objects: and
at least one processor for cooperation with the memory and the network interface, the processor configured to analyze the object in an initial state and the object's current ranking and then determine if a new block and associated object's blockchain needs to be generated as part of the ongoing plurality of transactions occurring within a supply chain electronic communication system that is applied to each function in a supply chain that includes procurement, production, storage, transportation and delivery of the object for optimization of the supply chain.

10. The system with integrity-ranked transactions for a supply chain electronic communication system according to claim 9, further includes the at least one processor determining at least one of cost, lead time, and quality for the object.

11. The system with integrity-ranked transactions for a supply chain electronic communication system according to claim 9, further includes objects are selected from the group consisting of actors, stock, supervisors, products, shipments, certificates, and transporters, and subjects are selected from the group consisting of actors smart contracts, supervisors smart contracts, products smart contracts, shipments smart contracts, certificates smart contracts and transporters smart contracts.

12. The system with integrity-ranked transactions for a supply chain electronic communication system according to claim 9, further includes the at least one processor optimizing the user, or the object based on system-wide performance metrics, wherein the system-wide performance metrics are selected from the group consisting of integrity, quality, cost, and lead time.

13. The system with integrity-ranked transactions for a supply chain electronic communication system according to claim 12, wherein the optimized user or optimized object combined with smart contracts optimizes supply chain operations to provide safety, traceability, and efficiency.

14. The system with integrity-ranked transactions for a supply chain electronic communication system according to claim 9, wherein the supply chain includes a supply chain in at least one of the following fields of manufacturing, food, agriculture, pharmaceutical, and healthcare to provide safety, traceability, and efficiency.

15. A method for utilizing integrity-ranked transactions in a supply chain electronic communication system comprising:
generating electronic content is received, the electronic content comprising a plurality of transactions for receipt by a plurality of users associated with a plurality of user accounts of the supply chain system, where each transaction has both a blockchain component and a ranking component with a network electronic interface:
utilizing a first plurality of memory addresses that are arranged as a plurality of user accounts, each account associated with a user and a second plurality of memory addresses associates the plurality of user accounts with transactions and associated objects with at least one memory; and
analyzing the object in an initial state and the object's current ranking and then determine if a new block and associated object's blockchain needs to be generated as part of the ongoing plurality of transactions occurring within a supply chain electronic communication system with at least one processor that cooperates with the memory and the network interface.

16. The method for utilizing integrity-ranked transactions in a supply chain electronic communication system according to claim 15, further comprising determining an initial rank of the user by an existing user and updated based on operational characteristics of the user.

17. The method for utilizing integrity-ranked transactions in a supply chain electronic communication system according to claim 15, further comprising applying to both the blockchain component and the ranking component for each function in a supply chain that includes procurement, production, storage, transportation, and delivery of the object for optimization of the supply chain.

18. The method for utilizing integrity-ranked transactions in a supply chain electronic communication system according to claim 15, further comprising utilizing smart contracts with the processor.

19. The method for utilizing integrity-ranked transactions in a supply chain electronic communication system according to claim 15, further comprising optimizing the user or the object based on system-wide performance metrics with the at least one processor, wherein the objects are selected from the group consisting of actors, stock, supervisors, products, shipments, certificates, and transporters and subjects are selected from the group consisting of actors smart contracts, supervisors smart contracts, products smart contracts, shipments smart contracts, certificates smart contracts and transporters smart contracts.

20. The method for utilizing integrity-ranked transactions in a supply chain electronic communication system according to claim 19, further comprising utilizing smart contracts optimizes supply chain operations to provide safety, traceability, and efficiency.
